(19) United States
(12) Patent Application Publication
(10) Pub. No.: US 2012/0075151 A1
(43) Pub. Date: Mar. 29, 2012

(54) MULTI-BAND ANTENNA DEVICE

(75) Inventors: Jatupum Jenwatanavet, San Diego, CA (US); Allen Minh-Triet Tran, San Diego, CA (US); Joe C. Le, Poway, CA (US)

(73) Assignee: QUALCOMM Incorporated, San Diego, CA (US)

(21) Appl. No.: 13/030,371

(22) Filed: Feb. 18, 2011

Related U.S. Application Data
(60) Provisional application No. 61/387,952, filed on Sep. 29, 2010.

(51) Int. Cl. H01Q 1/22; H01Q 1/48; H01P 11/00; H01Q 1/50

(52) U.S. Cl. 343/718; 343/860; 343/848; 29/601; 29/729

(57) ABSTRACT

Exemplary embodiments are directed to an antenna device. A device may include an antenna element including a first electrically conductive element oriented in a first direction and a second electrically conductive element oriented in a second, different direction, the first and second conductive elements being electrically connected at one respective end. The device may further include a matching circuit operably coupled to the antenna element.

### CLAIM OF PRIORITY UNDER 35 U.S.C. §119

This application claims priority under 35 U.S.C. §119(e) to: U.S. Provisional Patent Application 61/387,952 entitled “Multi-band Antenna for GPS Tracking Device Built in Lanyard Configuration” filed on Sep. 29, 2010, the disclosure of which is hereby incorporated by reference in its entirety.

### BACKGROUND

1. Field

The present invention relates generally to antenna device, and more specifically, to systems, device, and methods related to a multi-band antenna device.

2. Background

Recent advances in wireless communication devices, such as mobile phones or tracking devices, have motivated efforts to design antennas more suitable for use with such devices. Antennas are generally needed to meet design constraints being imposed on new devices including overall size, profile, weight, manufacturability, and functionality. Several factors are usually considered in selecting an antenna design for a device, such as the size, the bandwidth, and the radiation pattern of the antenna.

As will be appreciated by a person having ordinary skill in the art, antennas require adequate space to ensure proper performance. Accordingly, designing multi-band antennas for tracking devices has been challenging, as the size of tracking devices are small and space for an antenna is limited.

A need exists for methods, systems, and devices related to a multi-band antenna. More specifically, a need exists for methods, systems, and devices for a suitable sized multi-band antenna, which exhibits acceptable performance.

### BRIEF DESCRIPTION OF THE DRAWINGS

FIG. 1 illustrates a device including an antenna coupled to a ground plane, according to an exemplary embodiment of the present invention.

FIG. 2 is a drawing of the device of FIG. 1

FIG. 3 is a circuit diagram of a matching circuit, in accordance with an exemplary embodiment.

FIG. 4 illustrates a supportive device having an antenna device integrated therein, according to an exemplary embodiment.

FIG. 5 illustrates a supportive device having an antenna device integrated therein and positioned around a phantom body.

FIG. 6 is a plot illustrating antenna efficiency in a cellular band and an ISM band.

FIG. 7 is a plot illustrating antenna efficiency in a GPS band.

FIG. 8 is a plot illustrating antenna efficiency in a PCS band.

FIG. 9 is a flowchart illustrating a method, in accordance with an exemplary embodiment.

FIG. 10 is a flowchart illustrating another method, in accordance with an exemplary embodiment.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in drawing form in order to avoid obscuring the novelty of the exemplary embodiments presented herein.

Exemplary embodiments as described herein are related to a multi-band device including an antenna element. According to one contemplated configuration, the antenna element includes a first conductive element and a second conductive element connecting together at one end in a v-shape structure. More specifically, one end of the first conductive element may be operably coupled to one end of the second conductive elements with an angle existing between the first conductive element and the second conductive element. Furthermore, the multi-band device may include a matching circuit coupled between the antenna element and a ground plane, which may comprise, for example only, a printed wiring board, a printed circuit board, a flex connector, or any combination thereof. The antenna element may be coupled to a single port of the matching circuit. According to one exemplary embodiment, the multi-band device, including the antenna element, the matching circuit, and the ground plane may be supported by a wearable device, such as a lanyard. In accordance with one exemplary embodiment, the multi-band device, which may be configured to operate in a cellular band, a global positioning system (GPS) band, a personal communication service (PCS) band, and a industrial, scientific, and medical (ISM) band, may be implemented as a tracking device, such as a GPS tracking device.

The conductive elements are configured in a shape according to wearable dimensions of a wearable structure or garment (e.g., lanyard). In this example, the conductive antenna elements (e.g., wires) form a V-shape consistent with the wearable drape or fit of a lanyard. Accordingly, the V-shape wires are commonly connected individual conductors. These conductors may maintain a common connection node at the base of the V. The structure of the lanyard may provide nominal spacing of the V-shaped antenna structure from an RF absorptive body. Further spacing of the V-shaped antenna from the RF absorptive body may be accommodated by the inclusion of further structure (e.g., foam, or other spacing material) into the lanyard, resulting in less RF absorption by the body. The V-shaped antenna structure may be woven into the lanyard or otherwise affixed thereto.

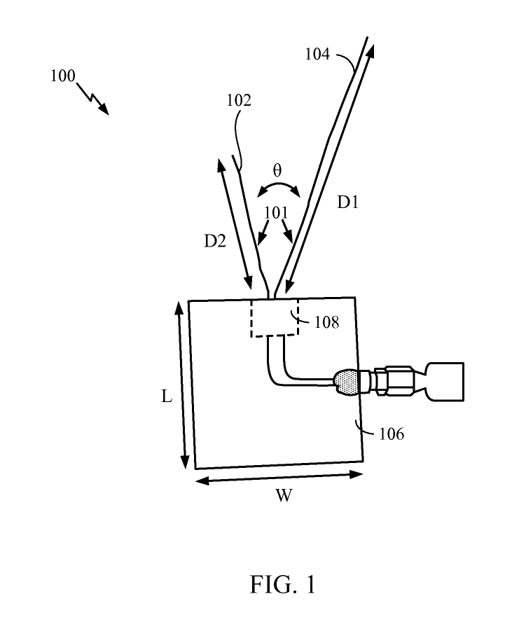

FIG. 1 illustrates a device 100 including an antenna element 101, in accordance with various exemplary embodiments of the present invention. According to one exemplary embodiment of the present invention, device 100 may comprise a tracking device, such as a low duty cycle (LDC) global positioning system (GPS) tracking device. Device 100 may include antenna element 101, which comprises a plurality of electrically conductive elements 102 and 104. By way of example only, electrically conductive elements 102 and 104 may each comprise a wire. As illustrated in FIG. 1, electrically conductive element 102 is oriented in a first direction and electrically conductive element 104 is oriented in a second, different direction. Further, one end of electrically conductive element 102 may be coupled to one end of electrically conductive element 104. More specifically, for example, electrically conductive elements 102 and 104 are connected together to form a “v-shaped” structure with an angle θ between wire 102 and 104. It is noted that electrically conductive element 102 may comprise a plurality of electrically conductive elements and electrically conductive element 104 may comprise a plurality of electrically conductive elements. It is further noted that antenna element 101 may comprise more than one loop.

For example only, wire 102 may have a length D2 in the range of substantially 40-60 mm and wire 104 may have a length D1 in the range of substantially 50-60 mm. As more specific examples, wire 102 may have length D2 of substantially 45 mm and wire 104 may have length D1 of substantially 58 mm. By way of example, angle θ may comprise an angle of substantially thirty degrees or more.

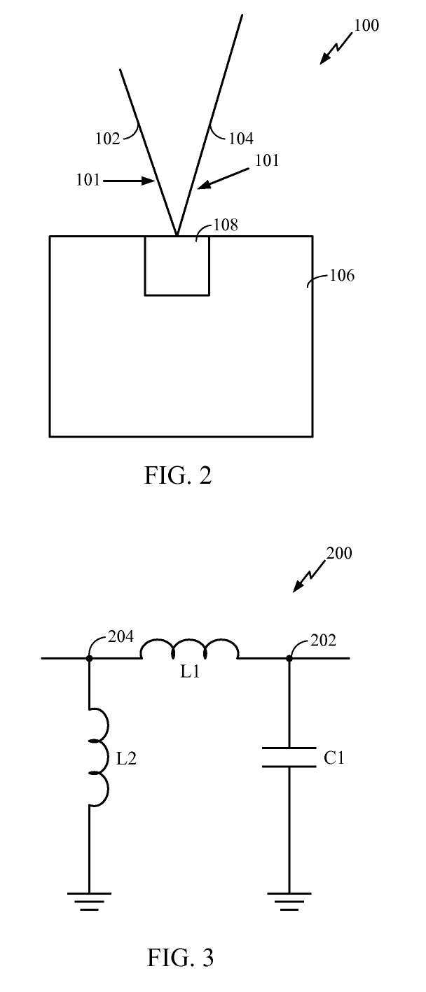

Device 100 may further include a matching circuit 108 coupled to a printed wiring board 106, which may comprise, for example, a printed wiring board of a tracking device, such as a GPS tracking device. Printed wiring board 106, which may also be referred to as ground plane 106. Matching circuit 108 may be coupled to each of electrically conductive element 102 and electrically conductive element 104. It is noted that electrically conductive elements 102 and 104 may be coupled to a single port of matching circuit 108. It is noted that ground plane 106 may be any suitable size. For example, a length L of ground plane 106 may in the range of substantially 40-60 mm and a width W of ground plane 106 may be in the range of substantially 30-50 mm. As more specific examples, ground plane 106 may have length L of substantially 50.5 mm and width W of substantially 38.9 mm. It is noted that if a length of either of electrically conductive element 102 or electrically conductive element 104 changes, the size of ground plane 106 may also need to be changed. Further, if a length of either of electrically conductive element 102 or electrically conductive element 104 changes, component values of matching circuit 108 may also need to be modified (i.e., the values of one or more of inductor L1, inductor L2 and capacitor C1 of FIG. 3). FIG. 2 illustrates a drawing of device 100 including antenna 101, which comprises electrically conductive elements 102 and 104. Further, device 100 includes ground plane 106 coupled to matching circuit 108. It is noted that although antenna element 101 is coupled to ground plane 106, antenna element 101 is not formed on nor physically supported by ground plane 106. Rather, as described more fully below, antenna element 101 may be supported by a wearable device.

It is further noted that device 100 may be configured as a multi-band device. By way of example only, operating frequencies of device 100 may include a cellular band (824 MHz-894 MHz), a GPS band (1565 MHz-1585 MHz) a PCS band (1850 MHz-1990 MHz) or a ISM band (902 MHz-928 MHz). More specifically, as an example, electrically conductive element 102 and electrically conductive element 104 may function together to service a cellular band, a GPS band, a PCS band, or an ISM band.

FIG. 3 depicts a circuit diagram of matching circuit 200. As illustrated, matching circuit 200 includes inductors L1 and L2 and capacitor C1. As non-limiting examples, inductor L1 may have an inductance in the range of substantially 5.6 nH to substantially 33 nH, inductor L2 may have an inductance in the range of substantially 2.2 nH to substantially 12 nH, and capacitor C1 may have a capacitance in the range of substantially 0.1 pF to substantially 3.0 pF. As more specific examples, inductor L1 may have an inductance of 15 nH, inductor L2 may have an inductance of 4.7 nH, and capacitor C1 may have a capacitance of 0.8 pF. According to one exemplary embodiment, electrically conductive element 102 and electrically conductive element 104 may each be coupled to port 202. Further, a port 204 of matching circuit 200 may be coupled to an RF circuit of printed wiring board 106.

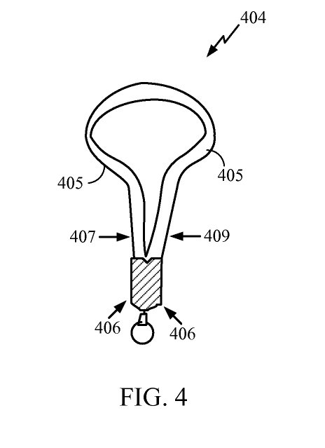

FIG. 4 illustrates a supportive device 404 having device 100 (see FIG. 1 or 2) integrated therein, in accordance with an exemplary embodiment of the present invention. It is noted that supportive device 404 may comprise any suitable device for supporting device 100. According to one exemplary embodiment, supporting device 404 may comprise a wearable device, such as, for example only, a lanyard, a necklace, a dog collar, or neck tie. As illustrated in FIG. 4, supportive device 404 includes a strip element 405 including a first end 407 and a second end 409. It is noted that strip element 405 may comprise any suitable material, such as rubber, vinyl, plastic, leather, or a combination thereof.

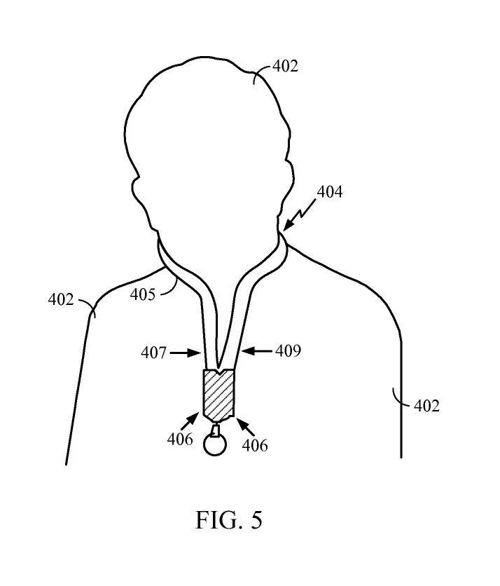

Supportive device 404 further includes an end piece 406 coupled to each of first end 407 and second end 409. With reference to FIGS. 1 and 4, it is noted that end piece 406 may include printed wiring board 106 and matching circuit 108. Furthermore, electrically conductive element 102 may extend from end piece 406 into first end 407 of strip 407 and electrically conductive element 104 may extend from end piece 406 into second end 409 of strip 407. FIG. 5 illustrates supportive device 404 having antenna device 406 integrated therein and positioned around (e.g., a neck of) a phantom body 402. It is noted that, for testing purposes, phantom body 402 comprises elements for simulating tissue of a human body.

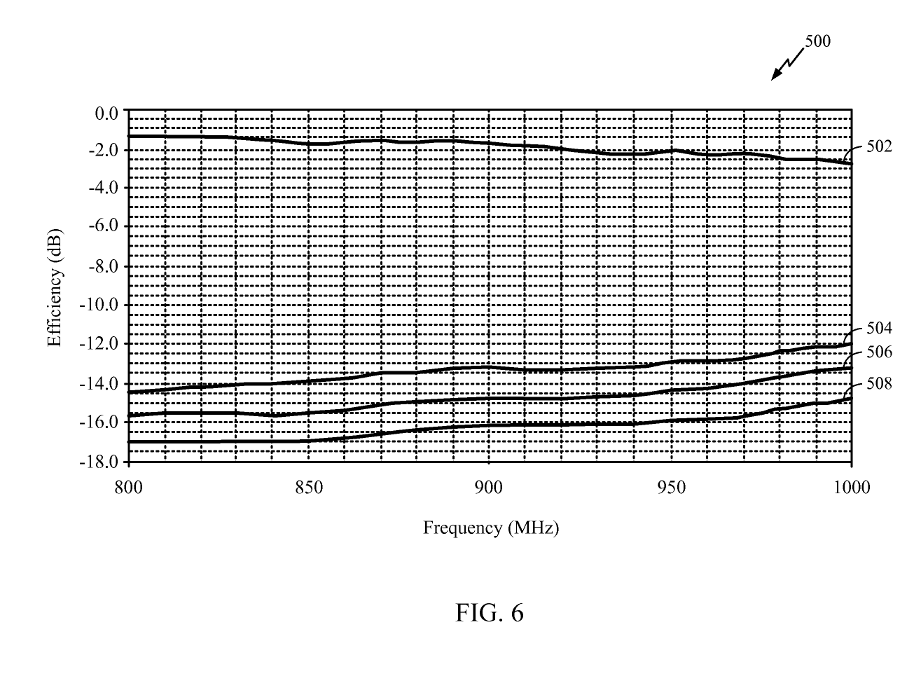

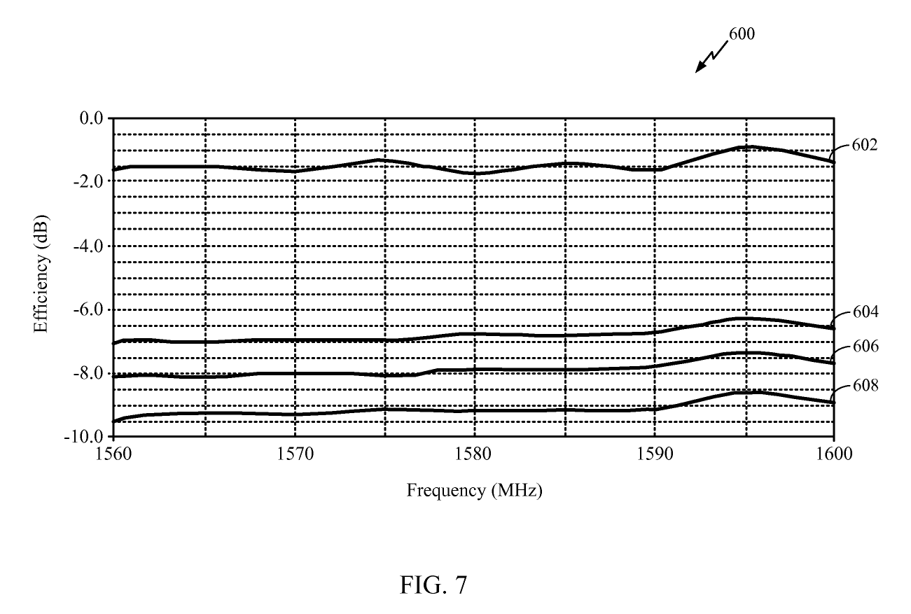

FIG. 6 is a plot 500 illustrating antenna efficiency in a cellular band. Signal 502 represents efficiency values across a range of frequencies for an antenna element (i.e., antenna element 101) in free space. It is noted that the efficiency of the antenna element in free space may be better than −2 dB. Signal 504 represents efficiency values across a range of frequencies for the antenna element integrated within a lanyard, which is spaced 5 mm from a phantom body. It is noted that in this example, although the lanyard was spaced 5 mm from a phantom body, the antenna element within the lanyard was spaced 8.5 mm from the phantom body, as the thickness of the lanyard is 3.5 mm. As illustrated in FIG. 6, the efficiency the antenna element spaced 8.5 mm from the phantom body is approximately −14 dB. Signal 506 represents efficiency values across a range of frequencies for the antenna element integrated within a lanyard, which is spaced 2.5 mm from a phantom body. It is noted that in this example, although the lanyard was spaced 2.5 mm from a phantom body, the antenna element within the lanyard was spaced 6 mm from the phantom body. As illustrated in FIG. 6, the efficiency of the antenna element spaced 6 mm from the phantom body is approximately −15.5 dB. Signal 508 represents efficiency values across a range of frequencies for the antenna element integrated within a lanyard, which immediately adjacent a phantom body. It is noted that in this example, although the lanyard was immediately adjacent the phantom body, the antenna element within the lanyard was spaced 3.5 mm from the phantom body. As illustrated in FIG. 6, the efficiency of the antenna element spaced 3.5 mm from the phantom body is approximately −17 dB.

FIG. 7 is a plot 600 illustrating antenna efficiency in a GPS band. Signal 602 represents efficiency values across a range of frequencies for an antenna element (i.e., antenna element 101) in free space. It is noted that the efficiency of the antenna element in free space may be better than −1.5 dB. Signal 604 represents efficiency values across a range of frequencies for the antenna element integrated within a lanyard, which is spaced 5 mm from a phantom body. It is noted that in this example, although the lanyard was spaced 5 mm from a phantom body, the antenna element within the lanyard was spaced 8.5 mm from the phantom body. As illustrated in FIG. 7, the efficiency of the antenna element spaced 8.5 mm from the phantom body is approximately −7 dB. Signal 606 represents efficiency values across a range of frequencies for the antenna element integrated within a lanyard, which is spaced 2.5 mm from a phantom body. It is noted that in this example, although the lanyard was spaced 2.5 mm from a phantom body, the antenna element within the lanyard was spaced 6 mm from the phantom body. As illustrated in FIG. 7, the efficiency of the antenna element spaced 6 mm from the phantom body is approximately −8 dB. Signal 608 represents efficiency values across a range of frequencies for the antenna element integrated within a lanyard, which immediately adjacent a phantom body. It is noted that in this example, although the lanyard was immediately adjacent the phantom body, the antenna element within the lanyard was spaced 3.5 mm from the phantom body. As illustrated in FIG. 7, the efficiency of the antenna element spaced 3.5 mm from the phantom body is approximately −9 dB.

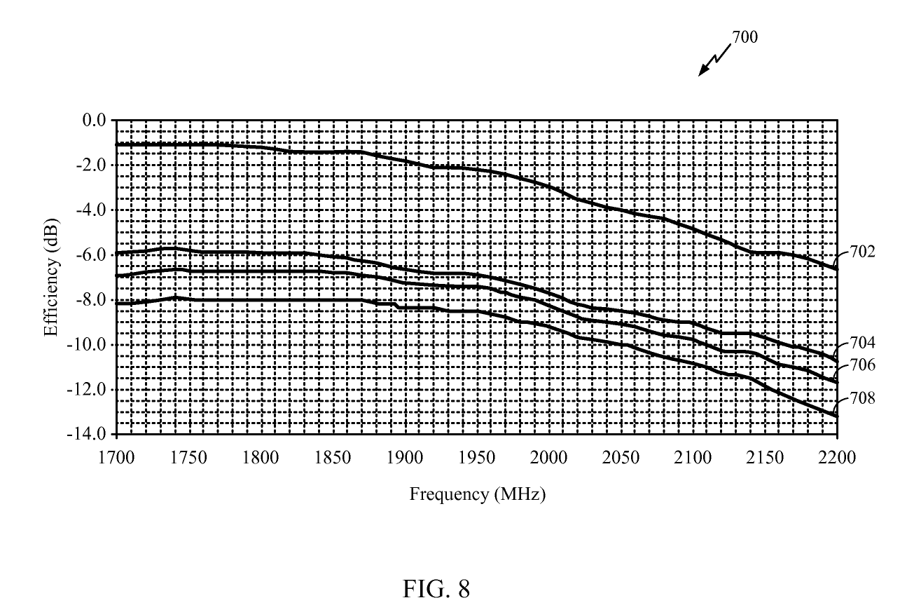

FIG. 8 is a plot 700 illustrating antenna efficiency in a PCS band. Signal 702 represents efficiency values across a range of frequencies for an antenna element (i.e., antenna element 101) in free space. It is noted that the efficiency of the antenna element in free space may be better than −2.5 dB. Signal 704 represents efficiency values across a range of frequencies for the antenna element integrated within a lanyard, which is spaced 5 mm from a phantom body. It is noted that in this example, although the lanyard was spaced 5 mm from a phantom body, the antenna element within the lanyard was spaced 8.5 mm from the phantom body. As illustrated in FIG. 8, the efficiency of the antenna element spaced 8.5 mm from the phantom body is approximately −7.5 dB. Signal 706 represents efficiency values across a range of frequencies for the antenna element integrated within a lanyard, which is spaced 2.5 mm from a phantom body. It is noted that in this example, although the lanyard was spaced 2.5 mm from a phantom body, the antenna element within the lanyard was spaced 6 mm from the phantom body. As illustrated in FIG. 8, the efficiency of the antenna element spaced 6 mm from the phantom body is approximately −8 dB. Signal 708 represents efficiency values across a range of frequencies for the antenna element integrated within a lanyard, which immediately adjacent a phantom body. It is noted that in this example, although the lanyard was immediately adjacent the phantom body, the antenna element within the lanyard was spaced 3.5 mm from the phantom body. As illustrated in FIG. 8, the efficiency of the antenna element spaced 3.5 mm from the phantom body is approximately −9 dB. It is noted that the measurements, which produced plots 500, 600, and 700, were done in an anechoic chamber.

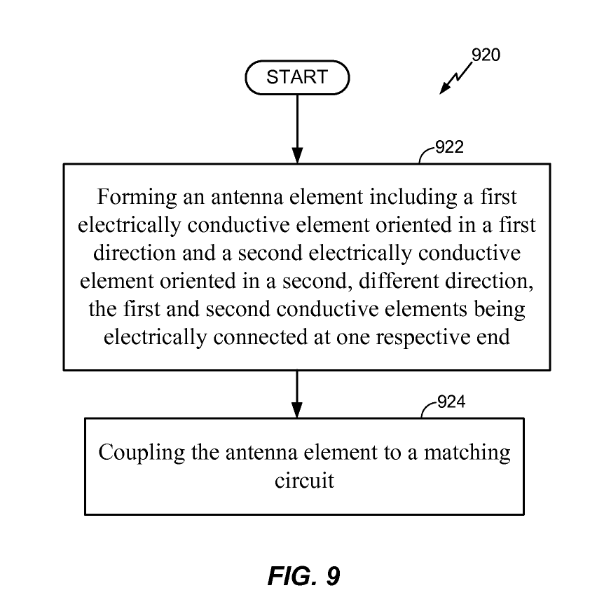

FIG. 9 is a flowchart illustrating a method 920, in accordance with one or more exemplary embodiments. Method 920 may include forming an antenna element including a first electrically conductive element oriented in a first direction and a second electrically conductive element oriented in a second, different direction, the first and second conductive elements being electrically connected at one respective end (depicted by numeral 922). Method 920 may further include coupling the antenna element to a ground plane (depicted by numeral 924).

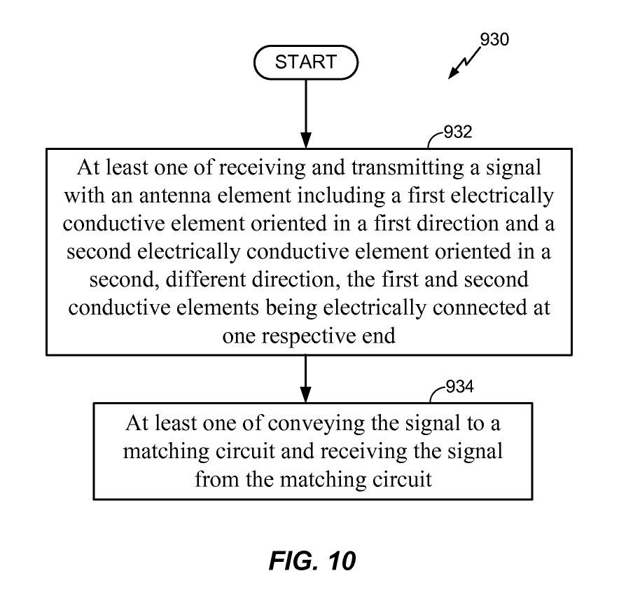

FIG. 10 is a flowchart illustrating a method 930, in accordance with one or more exemplary embodiments. Method 930 may include at least one of receiving and transmitting a signal with an antenna element including a first electrically conductive element oriented in a first direction and a second electrically conductive element oriented in a second, different direction, the first and second conductive elements being electrically connected at one respective end (depicted by numeral 932). Method 920 may further include at least one of conveying the signal to a matching circuit and receiving the signal from the matching circuit (depicted by numeral 934).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A device, comprising:
an antenna element including a first electrically conductive element oriented in a first direction and a second electrically conductive element oriented in a second, different direction, the first and second conductive elements being electrically connected at one respective end forming a v-shaped structure; and
a matching circuit operably coupled to the antenna element.

2. The device of claim 1, further comprising a wearable structure having each of the antenna element and the matching circuit integrated therein.

3. The device of claim 2, the wearable structure including first and second portions substantially respectively oriented in the first direction and the second directions, the first and second portions respectively associated with the first and second electrically conductive elements.

4. The device of claim 2, the wearable structure comprising one of a lanyard, a necklace, a dog collar, and a neck tie.

5. The device of claim 1, the device configured for operating in at least two of a cellular band, a GPS band, and PCS band, and an ISM band.

6. The device of claim 1, the first electrically conductive element having a length of substantially 45 mm and the second electrically conductive element having a length of 58 mm.

7. The device of claim 1, further comprising a printed wiring board having an RF circuit coupled to the antenna element via the matching circuit, a size of the printed wiring board being dependent on at least one of a length of the first electrically conductive element and a length of the second electrically conductive element.

8. The device of claim 1, further comprising a ground plane coupled to the matching circuit.

9. The device of claim 8, the ground plane having a length of substantially 50.5 mm and a width of substantially 38.9 mm.

10. The device of claim 1, each of the first electrically conductive element and the second electrically conductive element coupled to a single port of the matching circuit.

11. The device of claim 1, the matching circuit comprising a first inductor having an inductance of substantially 15 nH coupled to each of a second inductor having an inductance of substantially 4.7 nH and a capacitor having a capacitance of substantially 0.8 pF.

12. The device of claim 1, wherein an angle of substantially thirty degrees or more separates the first electrically conductive element and the second electrically conductive element.

13. A method, comprising:
forming a v-shaped antenna element including a first electrically conductive element oriented in a first direction and a second electrically conductive element oriented in a second, different direction, the first and second conductive elements being electrically connected at one respective end; and
coupling the antenna element to a matching circuit.

14. The method of claim 13, further comprising integrating the antenna element and the matching circuit in a wearable structure.

15. The method of claim 14, the integrating comprising integrating the antenna element and the matching circuit in a wearable structure including first and second portions substantially respectively oriented in the first direction and the second directions, the first and second portions respectively associated with the first and second electrically conductive elements.

16. The method of claim 14, the integrating comprising integrating the antenna element and the matching circuit in a lanyard.

17. The method of claim 13, the coupling comprising coupling each of the first electrically conductive element and the second electrically conductive element antenna to a single port of the matching circuit.

18. The method of claim 13, the forming comprising forming the first electrically conductive element and the second electrically conductive element to have an angle of substantially thirty degrees or more therebetween.

19. A device, comprising:
an antenna element including at least one first electrically conductive element having a length of substantially 45 mm and oriented in a first direction and at least one second electrically conductive element having a length of substantially 58 mm and oriented in a second, different direction, the at least one first and second conductive elements being electrically connected at one respective end forming a v-shaped structure;
a matching circuit operably coupled to the antenna element and comprising a first inductor having an inductance of substantially 15 nH coupled to each of a second inductor having an inductance of substantially 4.7 nH and a capacitor having a capacitance of substantially 0.8 pF; and
a ground plane operably coupled to the matching circuit and having a length of substantially 50.5 mm and a width of substantially 38.9 mm.

20. A method, comprising:
at least one of receiving and transmitting a signal with an antenna element including a first electrically conductive element oriented in a first direction and a second electrically conductive element oriented in a second, different direction, the first and second conductive elements being electrically connected at one respective end; and
at least one of conveying the signal to a matching circuit and receiving the signal from the matching circuit.

21. The method of claim 20, the at least one of receiving and transmitting a signal comprising at least one of receiving and transmitting a signal in one of a cellular band, a GPS band, and PCS band, and an ISM band.

22. A device, comprising:
means for at least one of receiving and transmitting a signal with an antenna element including a first electrically conductive element oriented in a first direction and a second electrically conductive element oriented in a second, different direction, the first and second conductive elements being electrically connected at one respective end; and
means for at least one of conveying the signal to a matching circuit and receiving the signal from the matching circuit.

23. The device of claim 22, further comprising means for at least one of receiving and transmitting a signal in one of a cellular band, a GPS band, and PCS band, and an ISM band.

24. A device, comprising:
means for orienting a first electrically conductive element in a first direction and a second electrically conductive element in a second, different direction to form a v-shaped antenna element, the first and second conductive elements being electrically connected at one respective end; and
means for coupling the antenna element to a matching circuit.

25. The device of claim 24, further comprising means for integrating the antenna element and the matching circuit in a wearable structure.

26. The device of claim 24, further comprising means for integrating the antenna element and the matching circuit in a wearable structure including first and second portions substantially respectively oriented in the first direction and the second directions, the first and second portions respectively associated with the first and second electrically conductive elements.

27. The device of claim 24, further comprising means for integrating the antenna element and the matching circuit in a lanyard.
